(19) United States
(12) Patent Application Publication
(10) Pub. No.: US 2003/0050019 A1
(43) Pub. Date: Mar. 13, 2003

(54) Mobile units with fexible-retractable peripherals

(76) Inventors: Eric Morgan Dowling, Bradenton, FL (US); Linda Joan Dowling, Bradenton, FL (US)

Correspondence Address: Eric M Dowling, Interlink 731, PO Box 02 5635, Miami, FL, 33102-5635, US

(21) Appl. No.: 09/949,533

(22) Filed: Sep. 7, 2001

(51) Int. Cl. H04B 1/38

(52) U.S. Cl. 455/90; 455/575

(57) ABSTRACT

A mobile unit such as a smart phone is augmented with one or more flexible-retractable peripherals in order to allow the mobile unit provide a non-area-constrained user interface to the user. For example, a smart phone provides an area-constrained and device-specific user interface to the user while the user is mobile. When the user wishes to work on desktop applications, a roller-mounted and retractable keyboard and LPD (liquid polymer display) are extended from the smart phone to provide a non-area constrained user interface. This allows a hand-held smart phone to optionally function as a laptop/desktop computer. The flexible-retractable peripherals may be built directly into the smart phone or may be implemented as stand-alone peripherals coupled to the smart phone using wired or wireless connections such as Bluetooth™ connections.

### BACKGROUND OF THE INVENTION

1. Field of the Invention

This invention relates generally to mobile Internet and mobile computing devices. More particularly, the invention relates to flexible-retractable peripherals that allow, for example, a hand-held mobile unit such as a smart phone to be converted into a laptop-style computer.

2. Description of the Related Art

Wireless networks have been evolving rapidly since the early 1980's when the first generation cellular telephone network was deployed. By this time the third generation network technologies are fairly well defined and initial deployments are beginning. Already, fourth generation systems are in the research phase. A key difference between the first generation systems and modem systems is the move from circuit switched analog technology to packet switched digital technology. While early cellular telephones were wireless versions of standard analog telephones, newer cellular and PCS (personal communication system) phones provide both voice and data channels. It is envisioned that in the future both the voice and data traffic will be carried by a unified packet switched network.

A key attribute of third generation (3G) cellular systems is their ability to handle data traffic. To the user, this means a cellular phone can provide Internet connectivity. A “smart phone” is a device that provides voice connectivity, data connectivity and computerized application programs such as those as offered by PDA (personal digital assistant) technology. For the purposes of this application, a smart phone is any hand-held computing device runs an operating system and application programs and can also connect to a network or other devices via an air interface (wireless connection). For example, the air interface may use a protocol such as 2.5G cellular, 3G cellular, 4G cellular, or a local wireless protocol such as IEEE 802.11, HomeRF™, or Bluetooth™.

A key problem faced by smart phones is their limited user interface capabilities. Smart phones need to be compact in design. As such, a typical smart phone has a relatively small display surface and a telephone-sized keypad. While a smart phone may be able to provide wireless Internet capabilities, its limited display surface area precludes it from providing a full featured web browser as found on desktop systems. Some prior art systems use speech recognition and voice based operating system techniques to address the user interface size constraints imposed by smart phones. Still, voice based user interfaces are cumbersome in the way they control complex data entry and menu navigation requirements that arise in operating systems and application programs such as spread sheets.

Prior art systems understand the restricted user interface capabilities of smart phones and similar mobile devices. As such, various dialects of XML (eXtensible Markup Language) have been developed to allow content to be customized for interactive display on specific types of smart phones and other mobile devices. A variation of XML known as WML (Wireless Markup Language) includes language constructs (e.g., tag sets) that allow a server to deliver customized content to a mobile device made by a specific manufacturer and having a specific model number. This allows the content to be customized for the device-specific configuration supplied by the mobile device.

In general, a device-specific user interface that involves a restricted display area and a fixed set of user interface buttons, such as those found on a smart phone or a PDA is called an “area-constrained user interface.” A user interface found on a desktop system such as a PC or workstations is called a “non-area-constrained user interface.” Laptop computers also have a display area large enough to fit into the non-area-constrained interface model. That is, general web browsers can display the same content on a laptop, a workstation, or a PC. This non-device-specific interface as used by web browsers for desktop and laptop systems is called a non-area-constrained user interface. Device-specific content does not need to be supplied to machines that support a non-area constrained user interface (moderate to large size monitor, keyboard and mouse). In some specific embodiments of non-area constrained user interfaces, the keyboard and mouse may be traded for a touch screen or other input means, but the display monitor must be big enough to support user viewing without the constraints of a small screen as is found on a hand-held device.

Typically, systems with non-area constrained user interfaces involve a desktop user interface. For example, a desktop user interface is found on computer systems such as those running the Windows™ or X-Windows™ operating systems. In general, any graphical user interface that allows a user to make menu selections and/or icon selections in a non-area constrained environment can be thought of as a desktop interface. Typically, desktop interfaces use pointing devices such as mouse devices and also provide optional keyboard support. Some desktop user interfaces also provide speech recognition and voice based prompts.

It should be noted that different models of smart phones and other mobile devices will have different display surface sizes and shapes, and different sets of keys on different types of keypads (area-constrained). This is in contrast to desktop systems that can all be assumed to have a desktop sized monitor, a standard keyboard, and a mouse (non-area constrained). While WML and similar technologies can be used to specify how content should be delivered to a variety of smart phone devices, the display surface area and keypad surface area limitations remain. A smart phone is generally limited in its set of peripherals and therefore is incapable of providing the type of user interface that can be supplied by computer systems with full sized display surfaces, keyboards, and other devices such as pointing devices.

Recent developments have brought about the concept of a flexible LCD display screen. For example, Phillips Research Laboratories has demonstrated a flexible display technology that uses a polymeric semiconductor material. This technology provides an active-matrix LPD (liquid polymeric display) technology that can be mounted onto flexible, bendable surfaces. A newer technology LPD technology by Visson Inc. (acquired by Philips) is able to make LPDs that can be rolled up like a newspaper. Also, because keyboard technology is relatively simple and is based on making and breaking electrical contacts, the technology exists to make a flexible roll-up keyboard.

It would be desirable to have a mobile unit that could provide a compact smart phone user interface (UI) to a user, but could then be reconfigured to support a full desktop style UI so that the user could work on desktop applications while away from the home or office. For example, it would be desirable for a user of a smart phone to use the phone's area-constrained user interface while mobile, but to then be able to sit down at a table-top and convert the smart phone into a laptop-equivalent system that uses a non-area-constrained user interface.

### SUMMARY OF THE INVENTION

The present invention solves these and other problems by providing systems and methods to enable a mobile unit to access an expanded set of peripherals. The present invention includes various aspects as outlined herein and in further detail in the detailed description below.

A first aspect of the present invention involves a stand-alone flexible-retractable peripheral system. The system includes a flexible-retractable peripheral surface such as an LPD display and/or a flexible keyboard. For example, the flexible-retractable peripheral surface can be extended from an enclosure using motor-driven or manually-driven roller system. The system also includes a coupling that couples signals to and/or from the peripheral to a hand-held mobile computing device. Such a stand-alone system enables the hand-held mobile unit to provide a non-area constrained user interface to a user, for example to provide laptop computer functionality or a video-viewing surface for video programming.

A second aspect of the present invention centers on a hand-held mobile unit. The hand-held mobile unit includes a processor, a memory and an area-constrained user interface that provides user input and/or output to the hand-held mobile unit. For example, the area-constrained user interface involves a driver circuit and a set of device-specific input-output hardware on the surface of the hand-held mobile unit. The hand-held mobile unit also includes a flexible-retractable peripheral such as a roller-mounted flexible display and-or a roller-mounted keyboard. Also included in the mobile unit is a coupling that selectively couples signals between the flexible-retractable peripheral and the processor. The mobile unit also includes a non-area constrained user interface. The non-area constrained user interface involves software and drivers that drive the flexible-retractable peripheral. The hand-held mobile unit selectively provides the area-constrained user interface and/or the non-area constrained user interface depending on an operating mode of the hand-held mobile unit. For example, when the user causes the flexible-retractable peripheral to assume its extended state, the coupling couples a software-driven non-area constrained user interface to the flexible-retractable peripheral. The mobile unit uses its indigenous operating system and application interfaces and/or may interact with a remote server such as an application server (e.g., using a non-area constrained web browser) in order to supply the non-area constrained user interface using the flexible-retractable peripheral surface.

In a third aspect of the present invention, a method is provided for use with a stand-alone flexible-retractable peripheral system. A flexible-retractable peripheral is extended. The flexible-retractable peripheral can be, for example, a flexible display and/or a flexible keyboard. The system advertises a service via a wireless link. The advertisement is indicative of a peripheral service provided by the extended flexible-retractable peripheral. The system next engages in a service discovery protocol sequence with a mobile unit via a short-range wireless connection. Next the system couples the flexible-retractable peripheral service to the mobile unit. Finally, the system provides an input and/or output peripheral service to the mobile unit using the extended surface of the flexible-retractable peripheral.

The present invention includes a variety of other aspects. These other aspects variations of or extensions to the ones provided above. For further details, see the detailed description of the preferred embodiments.

### BRIEF DESCRIPTION OF THE FIGURES

The various novel features of the present invention are illustrated in the figures listed below and described in the detailed description that follows.

FIG. 1 is a block diagram representing an embodiment of a hand-held mobile unit that supports both an area constrained user interface and a non-area constrained user interface using flexible-retractable peripherals.

FIG. 2 is a flow chart representing an embodiment of a method practiced by a hand-held mobile unit to support both an area constrained user interface and a non-area constrained user interface using flexible-retractable peripherals.

FIG. 3 is a schematic drawing illustrating the front of a hand-held mobile unit that uses flexible-retractable peripherals.

FIG. 4A is a schematic drawing illustrating the back view of a hand-held mobile unit that uses flexible-retractable peripherals and a hinged support structure.

FIG. 4B is a schematic drawing illustrating the bottom view of a hand-held mobile unit that uses flexible-retractable peripherals and a downward protruding support structure.

FIG. 5 is a schematic drawing illustrating a stand-alone flexible-retractable peripheral device with a linked rigidity support system.

### DETAILED DESCRIPTION OF THE PREFERRED EMBODIMENTS

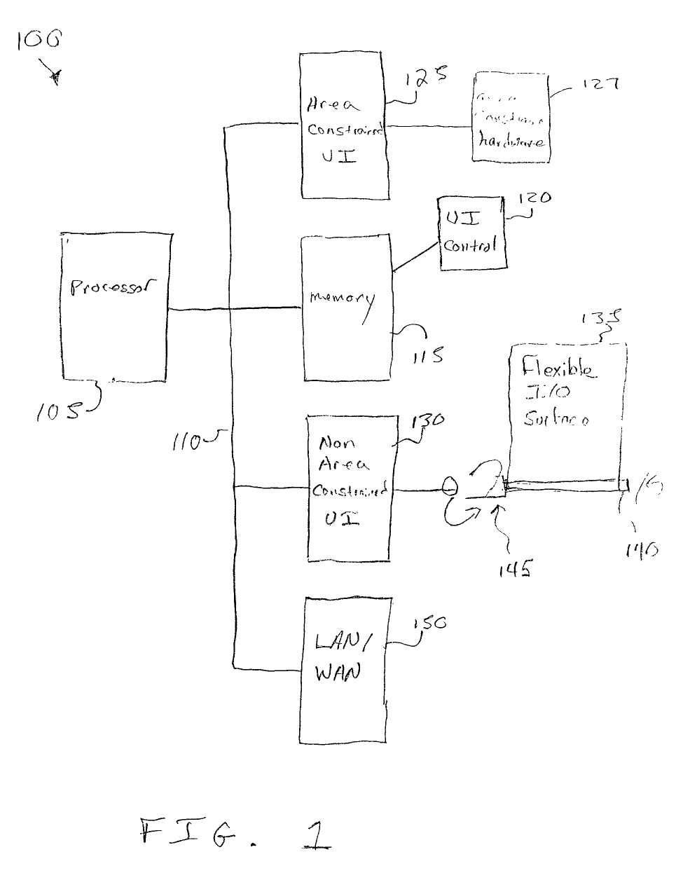

FIG. 1 is a block diagram illustrating an embodiment of a hand-held mobile device 100 designed in accordance with the present invention. A processor 105 is coupled via a bus 110 to a set of system components. The bus 110 may be implemented by a standard computer bus involving a set of unbroken wires that include data, address and control lines. More generally, the bus 110 may be implemented as a collection of point-to-point of connections or any other connection topology that allows the processor to communicate with the other components in the system. In some embodiments a direct memory access controller or other point to point connections can be used to allow various components to communicate with one another without intervention by the processor 105. The bus 110 is representative of any or all of such communication means, depending on the specific embodiment.

The processor 105 is coupled to a memory 115. The memory 115 stores program code and data for use by the processor. In some embodiments more than one physical memory may be used, for example separate memories may be used for program code and data. Also, in some embodiments more than one processor may be used in which case the processor 110 is representative of multiple processors and the memory 115 is representative of a shared or distributed memory system.

In the memory 115 is a user interface (UI) control module 120. The UI control module is a program module that runs on the processor 105. Other programs in the memory 115 include an operating system and a set of application programs.

The processor 105 is also coupled to an area-constrained UI driver 125. The area-constrained UI driver 125 accepts input and output commands from the processor 105 and responsively controls an area-constrained user interface peripheral set 127 that supplies a device-specific set of input and output channels to the user. For example, a specific smart phone provides a user with a specific display screen and a set of user input keys, and possibly touch screen input capability and/or a speech interface.

The processor is also coupled to a non-area constrained UI driver 130. The non-area constrained UI driver 130 is controllably coupled to a flexible I/O surface 135. The flexible I/O surface 135 may involve a flexible LCD and/or LPD monitor mounted on a roller and/or a flexible keyboard mounted on a roller 140. The non-area constrained UI driver 130 is electrically coupled to the flexible I/O surface 135 using a rotatable electrical coupler 145 such as a set of brush contacts or an optical coupler. The rotatable electrical coupler 145 allows the driver 130 to send and/or receive electrical signals to and/or from the peripheral 135. The peripheral 135 is flexible and is retractable because it is mounted on the roller 140. In some embodiments, the roller may be omitted the flexible peripheral 135 may be retracted using an accordion-style or some other retraction technique. The roller represents a preferred embodiment of the present invention and will be developed further herein by way of example.

The flexible-retractable peripheral may involve a display surface, a keyboard, a touch screen, or a stylus-writable screen as are found on PDA devices. Flexible LCD displays are created, for example using polymeric semiconductor materials (LPD's). Other flexible technologies are under development. Input devices such as keypads and touch screen input devices can be readily embedded into flexible material. For example a course or fine matrix of contact points can be embedded into a layer of the flexible material so that when pressure is applied, a contact is made in a given cell of the matrix. Standard matrix scanning techniques can be used to debounce the inputs determine which key has been pushed or what display cells have been selected.

The processor is also coupled to a LAN/WAN interface module 150. The LAN/WAN interface module represents a physical layer device for a wireless wide area network (WAN) and/or a wireless local area network (LAN). The wireless wide area network may involve, for example a 2.5G, 3G, or 4G cellular or PCS carrier with telephone and data services. The local area network may involve, for example an IEEE 802.11 LAN or a personal area network such as a Bluetooth™ physical layer connection. The rest of the protocol layers of the WAN and/or LAN are generally implemented as computer code in the memory 115.

In operation, the hand-held mobile unit 100 supplies a device-specific and area-constrained user interface to a mobile user. A network server provides information to the mobile unit 100 by customizing content to the device-specific and area-constrained user interface supplied by the mobile unit. For example, the server supplies content encoded using WML (wireless markup language) for interactive display on the device-specific and area-constrained user interface. Similarly, a set of local application programs and an operating system that reside at least partially in the memory 115 customize content for interactive display on the device-dependent area-constrained user interface.

In response to a user-initiated event, the local operating system, application programs, and/or the remote server detect a configuration change indication. For example the user pulls out a flexible and retractable LCD or LPD screen and a flexible and retractable keyboard that are mounted on roller devices. When the flexible peripherals are pulled into their opened positions, the UI control unit 120 detects this change of state and executes a reconfiguration command that causes the user interface to switch from the area-constrained user interface to the non-area constrained user interface. Now the operating system, application programs, and remote server programs can deliver content for interactive viewing using the non-area constrained user interface.

In some systems certain inputs from the area-constrained user interface set may be used to help control the non-area-constrained user interface. For example, a button on the hand-held mobile unit 100 may be used as a mouse-pointing device to control a cursor and user selections on the flexible LCD/LPD display surface that is in its rolled-out position. For example, a user button on the hand-held unit 100 is used as the mouse, the flexible roll-out key board is used for user typing and the roll-out LCD/LPD display surface is used for user display output.

The foregoing discussion describes hand-held mobile 100 unit includes a processor 105, a memory 115 and an area-constrained user interface 125, 127 that provides user input and/or output to the hand-held mobile unit. The hand-held mobile unit 100 also includes a flexible-retractable peripheral 135 such as a roller-mounted flexible display and-or a roller-mounted keyboard. Also included in the mobile unit is a coupling 130 that selectively couples signals between the flexible-retractable peripheral and the processor. The mobile unit also includes a non-area constrained user interface. The non-area constrained user interface involves software and drivers that drive the flexible-retractable peripheral 135. The hand-held mobile unit selectively provides the area-constrained user interface and/or the non-area constrained user interface depending on an operating mode of the hand-held mobile unit. For example, when the user causes the flexible-retractable peripheral to assume its extended state, the coupling couples a software-driven non-area constrained user interface to the flexible-retractable peripheral. The mobile unit uses its indigenous operating system and application interfaces and/or may interact with a remote server such as an application server (e.g., using a non-area constrained web browser) in order to supply the non-area constrained user interface using the flexible-retractable peripheral surface.

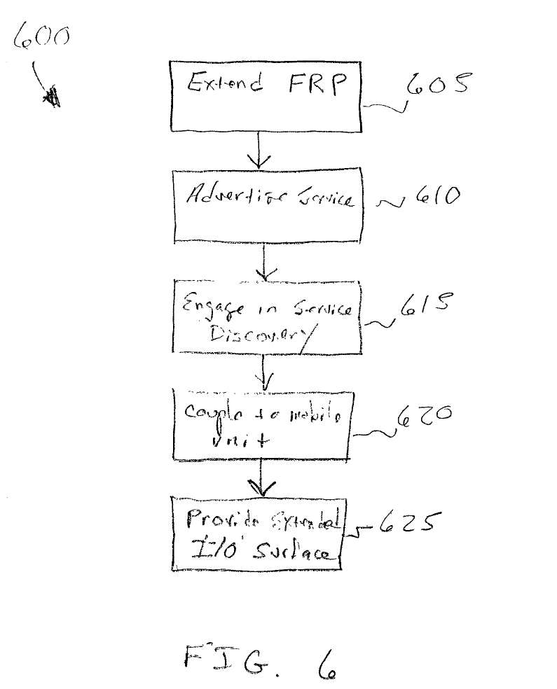

In alternative embodiments, as will be discussed in connection with FIG. 5, the flexible-retractable peripherals may be implemented as separate devices apart from the hand-held unit 100. For example, separate roll-out housings may be used for the keyboard and the LCD or LPD display. A personal area network such as a Bluetooth™ network may be provided to couple the peripherals to the handheld device 100. For example, in such embodiments, the LAN/WAN interface 150 includes a Bluetooth™ interface and the non-area constrained UI driver 130 is coupled to the processor 105 via the Bluetooth™ link.

A variant of the mobile unit 100 is a “generic mobile unit 100.” The generic mobile unit 100 is a variant that does not include the components 135, 140 and 145. The generic mobile unit 100 uses its LAN interface 150 to communicate with an external and stand-alone flexible-retractable peripheral 500 as discussed in connection with FIG. 5 and/or FIG. 6. The generic mobile unit 100 may use a short-range wireless protocol or a wired protocol to communicate with the external, stand-alone peripheral 500. The generic mobile unit 100 can present an area-constrained user interface to the user using it's device-specific I/O hardware 127 as controlled by the area-constrained UI driver 125. The generic mobile unit can negotiate with the external flexible-retractable peripheral 500 and use its services to provide a non-area constrained UI or an extended viewing surface such as for video viewing in a vehicle. At the present time, refresh rates for flexible displays are relatively slow, but motion picture viewing is possible and its quality (resolution and sustainable frame refresh rate) is expected to improve in the near future.

In accordance with an aspect of the present invention, the generic mobile unit 100 uses the memory 115 to hold one or more video programs. The video programs are stored in a compressed digital format such as MPEG-1 or some other video compression format such as a wavelet based video compression format. The area constrained user interface 125, 127 is used to control the downloading of video programs into the memory 115 or to cause video to be streamed into the generic mobile unit 100 via the LAN/WAN interface 150. The area-constrained UI hardware 127 preferably includes a small viewing surface for viewing, but this is optional. This variant of the generic mobile unit 100 uses the LAN (or PAN) aspect of the LAN/WAN interface 150 to transmit the video content to the external stand-alone flexible-retractable peripheral 500. This embodiment of the present invention enables a class of hand-held (or wristwatch-worn) video players that enable users to view music videos and other forms of recorded video programming (television shows, movies, etc.). In a system in accordance with the present invention the video player involves the previously described video player and the external peripheral 500. The inventive system also preferably implements the method 600. In a preferred embodiment, the external peripheral 500 includes a video decoder circuit in its electronics section (510) so that the mobile unit can transmit the video programming in the compressed format. In some cases it will be possible for the external peripheral 500 to be powered by a power source such as a car battery, as will be evident from the discussion below. Further discussions of such embodiments are provided in connection with FIG. 5 and FIG. 6.

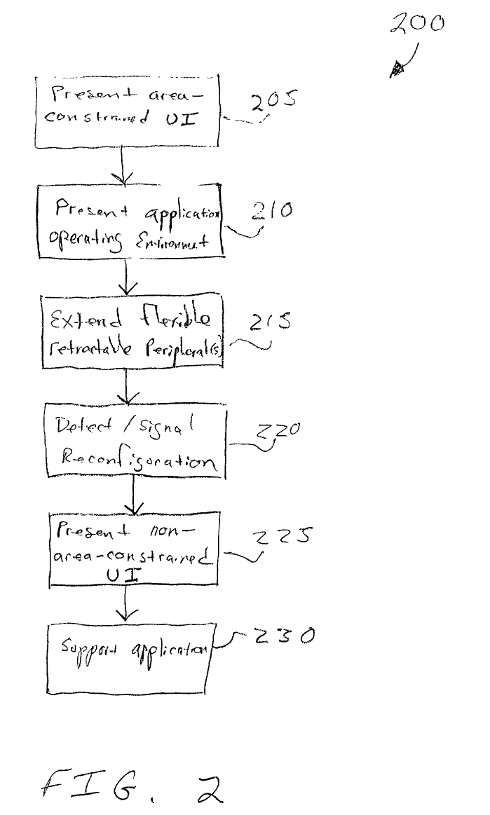

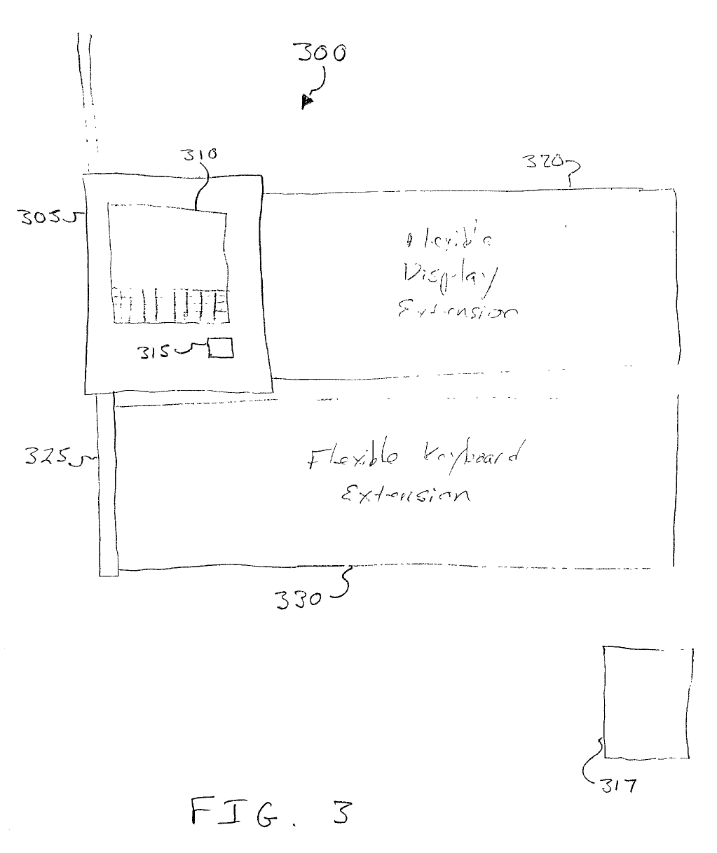

FIG. 2 illustrates a method of processing 200 used in a handheld mobile unit such as a smart phone. The hand-held mobile unit presents an area-constrained user interface to a user (205). The area-constrained user interface is supported by a set of device-specific user interface hardware such as found on the front of a smart phone device. The hand-held mobile unit also provides an operating system environment for the user to run local and/or remote application programs (210). The remote application programs are typically provided by a remote Internet server or a network server supplied by a carrier network. In some cases the remote programs are supplied by a local server such as one coupled to a wireless LAN such as an 802.11 LAN or a Bluetooth™ LAN (also called a PAN—personal area network).

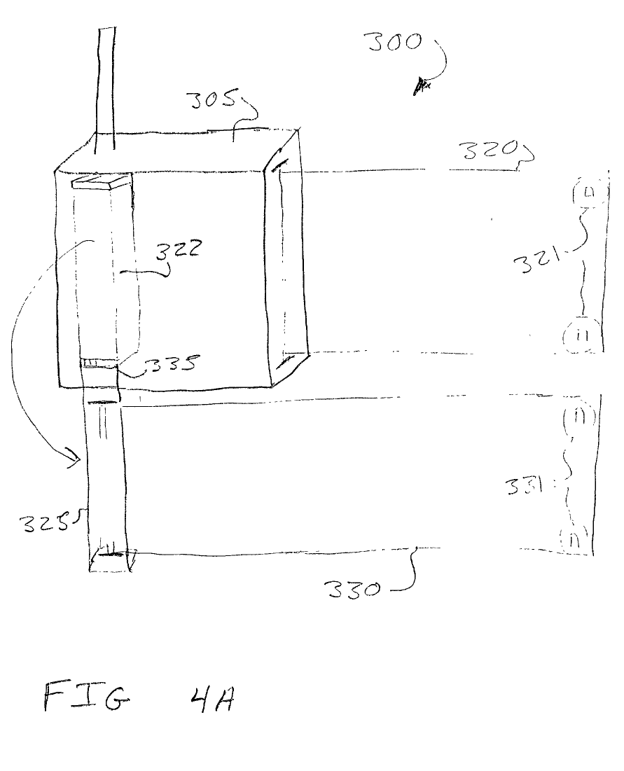

Next the handheld unit extends a set of one or more flexible-retractable peripherals (215). For example these peripherals are supplied on one or more rollers and the user pulls them out or one or more motors cause them to automatically roll out. Similarly to some cameras, a fold-out crank lever can also be used to manually crank the flexible-retractable peripheral from its housing. In other examples the flexible-retractable peripherals are extended by pulling them from a contracted accordion-like state. A motor can also be used to extend or retract accordion-style flexible-retractable peripherals. The flexible-retractable peripherals preferably include a keyboard and a LCD display monitor. A configuration change is signaled once the flexible peripherals are in their extended state or when a user hits a reconfiguration button or otherwise signals reconfiguration (220). Next the handheld mobile unit is operated with a non-area-constrained user interface using the extended peripherals and possibly an extra mouse device such as an external Bluetooth™ mouse or by using a button supplied on the area-constrained user interface of the handheld unit (225). In some embodiments the mouse device may be built into the flexible-retractable keyboard or LCD display monitor. In embodiments that use external peripherals as illustrated in FIG. 5, the mobile unit 100 may include an optical input-output coupling so that the mobile unit 100 itself may be used as an optical mouse (similar to the Microsoft™ optical mouse). The non-area constrained UI is used to support a non-area constrained operating system interface and/or a local or remote application program. This method and its variants will be better understood in light of FIGS. 3-5.

FIG. 3 is a schematic drawing illustrating a front view of a hand-held mobile unit 300 that uses flexible and retractable peripherals. The hand-held mobile unit 300 includes a hand-held enclosure 305. The hand-held enclosure 305 may be designed in various ways to provide a given look, feel and style to the user. The hand-held enclosure 305 may embody a smart phone, a PDA, a video player or other mobile computing device. The hand-held enclosure 305 houses the electronics as indicated by FIG. 1. Onto the hand-held enclosure 305 is built a device-specific input-output interface 310 that supports an area-constrained user interface. For example, a local application program or a remote WML-based application server will provide specialized content for display on the device-specific and area-constrained user interface hardware 310. As shown in FIG. 3, the device-specific hardware 310 typically includes a display surface and input buttons. In touch-screen-based embodiments the display surface and the input areas may overlap entirely or partially. Also, other types of user interfaces such voice input-output may be added or substituted in some embodiments to supply the area-constrained user interface.

Also shown in FIG. 3 is an optional mouse button 315. This mouse button may also double as a button supplied by the area-constrained user interface 310. Also, an external mouse device 317 may be used. The mouse device is used to control a cursor and to make user selections on a non-area constrained display surface 320. The non-area constrained display surface is a flexible-retractable display surface such as a flexible LCD or LPD monitor. As discussed previously, the flexible-retractable display surface 320 can be pulled out of the hand-held enclosure 305 using a roller or an accordion-style retraction technique. Much like a window blind, the display surface 320 can be pulled out of the enclosure 305. Also like a window blind, the display surface can be rolled back (retracted) into the enclosure 305 when it is no longer needed. Either a window blind retraction technique or a motorized retraction technique may be used to retract the display surface 320 back into the enclosure 305. Other extension-retraction techniques may be applied, but a roller is preferred.

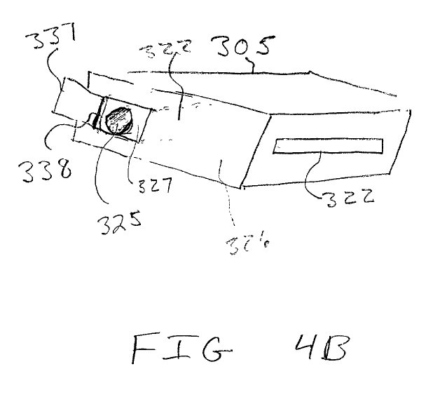

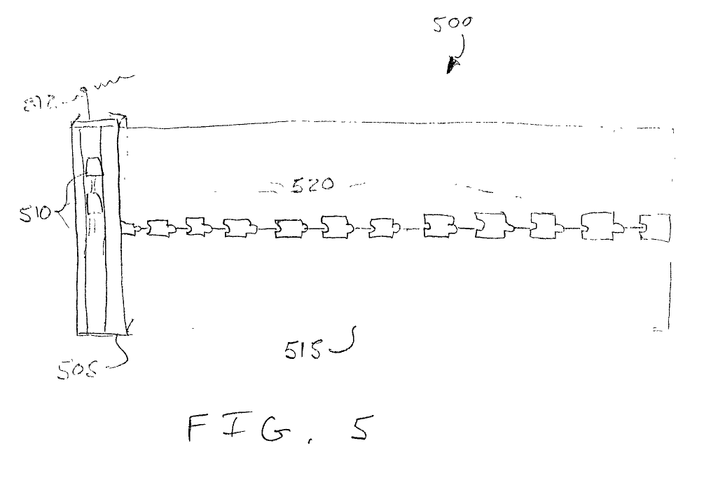

An optional second extension/retraction module 325 is provided to allow a second flexible-retractable peripheral to be extended and retracted. The second and optional extension/retraction module 325 uses a roller or similar technique for extension and retraction as discussed in connection with the surface 320. As will be discussed in connection with FIG. 4, the second and optional extension/retraction module 325 can be hinged or can be pulled down either by the user or under the control of a motor such as a stepper motor.

In an alternative embodiment, as discussed in connection with FIG. 5, the flexible-retractable peripherals 320, 330 are provided in stand-alone enclosures separate from the enclosure 305. Also, as discussed in connection with FIG. 5, the flexible-retractable peripherals 320, 330 may optionally use a set of movable links to provide rigidity in one or more dimensions to the flexible peripherals once they are extended.

Turning now to FIG. 4A, a back view of an embodiment of the hand-held mobile unit 300 is illustrated. A cavity 322 is built into the enclosure 305 to house the extension/retraction module 325. In this embodiment, a hinge 335 is used to allow the extension/retraction module 325 to flip out from the enclosure 305. Once the extension/retraction module 325 is flipped out on its hinge, the user can pull out the flexible-retractable peripheral 330. Likewise, a motor in the extension/retraction module 325 can cause the flexible-retractable peripheral 330 to be extended. For example, this motor can apply torque to a roll-up cylinder around which is wrapped the flexible peripheral 330 when in a retracted state. Also shown in FIG. 4A are optional placeholders 321 and 331. For example, suction cups can be used to hold the flexible peripherals 320 and 330 in place once they are in their extended states. As discussed in connection with FIG. 5, a plurality of movable links can be also be used to lock the peripherals 320 and 330 in place once they are extended.

FIG. 4B is a schematic drawing illustrating a bottom view of an embodiment of the hand-held mobile unit 305 implemented with a flexible-retractable peripheral that uses a downward protruding support structure. In this figure, the area-constrained UI surface is pointing downward and the back of the mobile unit 305 is pointing upward. On the bottom face 326 of the mobile unit 305 is a hinged cover 337 connected to a hinge 338. In some embodiments the hinged cover 337 may not use a hinge but instead a pocket-sliding door arrangement that is coplanar with the bottom face 326. In either case, an opening is provided whereby the extension/retraction module 325 can be extended and retracted from the cavity 322 via a bottom opening 327. The extension/retraction module 325 can be pulled down or can be pushed down by a mechanical force (e.g., spring or motor generated). Once extended, the extension/retraction module 325 looks substantially the same as in FIG. 4B, except instead of coming out of the cavity 322 via a hinge, , the extension/retraction module 325 protrudes downwardly from the bottom opening 322. Once the extension/retraction module 325 is extended into its downward protruded state, it can be used to extend and retract the flexible peripheral surface 330 as previously discussed. In embodiments where a crank is used, the crank is preferably implemented as a flip-out lever on the bottom of the extension/retraction module 325. Such cranks are similar to those used in some cameras to crank film. The flexible peripheral 320 can be pulled, cranked, pushed out by a stepper motor, or otherwise extended using from its retracted position using a side access 322.

FIG. 5 is a schematic drawing illustrating a stand-alone flexible-retractable peripheral device 500 with a linked rigidity support system 520. A stand-alone enclosure 505 is used to house a flexible-retractable peripheral 515. The shape of the enclosure 505 is rectangular or cylindrical. The exact shape of the cross-section of the enclosure 505 can be modified without departing from the scope of the present invention. Similarly to the mobile phone 300, the stand-alone flexible-retractable peripheral device 500 includes a side opening and an extension/retraction member such as a roller. The roller can be operated manually like a window blind, cranked, or can be operated using a motor as previously discussed. The roller is used to extend and retract the flexible-retractable peripheral 515. As previously discussed, other extension/retraction means such as an accordion-style folding arrangement can also be used in some embodiments.

Into the enclosure 505 or onto the flexible peripheral 515 are built a set of interface and control circuits 510. The interface and control circuits, for example include power supply circuits and a Bluetooth™ personal area network interface protocol stack that allows the stand-alone peripheral 500 to be coupled to a generic mobile unit such as a smart phone or a video player that has a Bluetooth™ LAN capability but no indigenous flexible-retractable peripherals. The alone flexible-retractable peripheral device 500 includes an antenna 512. In a preferred embodiment, the antenna 512 is flush with the enclosure 505 or is otherwise built into the enclosure 505 so that it does not protrude from the enclosure 505. Also, while Bluetooth™ is used by way of example, other short-range wireless air interfaces may be used to couple the stand-alone peripheral 500 to the mobile unit. The mobile unit discussed in connection with FIG. 5 and FIG. 6 may be a generic mobile unit (no indigenous flexible-retractable peripherals) or may include one or more flexible-retractable peripherals but use the external peripheral 500 for further augmentation.

In the illustrative embodiment 500, an optional linked rigidity system 520 is included. The links are illustrated as being farther apart than in their actual implementation for purposes of illustration only. A manual mechanical lever or a motorized mechanical stepping device is used to push on the linked rigidity system, for example, from left to right. When each link is joined with its successive link, the links lock together and become rigid. The linked rigidity system allows the flexible retractable display to become rigid once it has been extended to its extended position. This allows the peripheral to be used, once extended, without bending or rolling back up. In some embodiments, more than one linked rigidity system 520 can be used to provide added stability, for example one at the top of the peripheral 515, one in the middle and one at the bottom. In some embodiments the links can be implemented as a set telescoping and retractable sections. A key element is that a set of mechanical objects are joined together to support rigidity once the flexible-retractable peripheral is extended. For example, whether this support structure is retracted into the housing 505 or whether it is made unrigid by loosening a coupling between links is embodiment-dependent. A preferred embodiment of an aspect of the present invention uses a linked rigidity support structure as schematically illustrated in FIG. 5.

It should be noted that in certain embodiments whereby the peripheral 500 is mounted into a larger system such as a vehicle, guiding tracks or clasps (not shown) may be used to ensure the extended surface 515 remains rigidly in place. The links 520 are an optional aspect of the present invention. The tracked and clasped embodiments are discussed in further detail hereinbelow.

In an exemplary embodiment, a user has a smart phone that is equipped with a Bluetooth™ connection and a 3G wireless WAN connection. The user carries two peripheral devices 500 in his or her pocket or purse or briefcase; one for a keyboard and one for a display monitor. While mobile, the user uses the smart phone to support mobility applications. When the user is stationary and needs the services of a laptop computer, the flexible-retractable peripherals are brought to their extended states. This triggers a service advertisement sequence using the Bluetooth™ protocol. The mobile unit then initiates a Bluetooth™ service discovery protocol. In response thereto, the peripherals 500 become coupled to provide the smart phone with a keyboard and a display monitor. For a mouse, either a separate Bluetooth™ mouse 317 is used, or a button on the mobile phone's device specific user interface is used, or an input device on one of the flexible-retractable peripherals is used. Also, the mobile phone can include an optical input/output circuit so that the mobile phone itself can be moved around and serve an optical mouse. This allows the user to operate a standard smart phone with a Bluetooth™ connection in substantially the same way as the mobile unit 100 and 300. Smart phones with one or more peripherals 500 can operate according to the method 200.

As is discussed in greater detail in connection with FIG. 6, an aspect of the present invention involves mounting the peripheral 500 into a customized user environment. For example, the enclosure 505 can be built into the right-back side of the driver's seat in a car. In this case FIG. 5 illustrates how a display screen 515 can be extended across the back of the driver's seat so a back-seat passenger can view a retractable screen for computer or video applications, for example. In some such embodiments a set of one or more clasps (not shown) may be mounted to the left-back side of the driver's seat to hold the display surface 515 in place once it is in its extended position. Similarly, a motor could cause the display surface 515 to move along a set of fixed guides to keep the screen 515 on a track. All such embodiments are illustrated by FIG. 5 and the accompanying textual descriptions of FIG. 5 and FIG. 6. FIG. 5 is also representative of other customized installations of the peripheral 500 in accordance with the present invention. For example, an airplane environment for air passengers as is discussed in further detail hereinbelow.

Other such customized installations of the peripheral 500 are contemplated by the general concepts of the present invention. That is, it is anticipated that the peripheral 500 will be mounted into specific user environments controlled or owned either by the user or a third party that makes the peripheral 500's services available to the user either under a specific fee structure or without fees in order to supply customer amenities to customer to make their business environment more attractive and enticing to prospective customers. In a business method, a business makes the peripheral 500 available to its customers and practices a variant of the method 600 as described below. In another business method a business supplies the peripheral 500 installed into a customized user environment and practices a variant of the method 600 whereby user fees are assessed to the user. In another business method, the business sells products such as vehicles with the peripheral 500 mounted into specific locations such as the passenger-side dashboard and/or the backs of the front seats. Like roll-up windows, the passengers can mechanically or electronically cause the surface 515 to be extended and can then use the peripheral 500. Depending on the embodiment, the user may use the peripheral 500 with a hand-held mobile unit or a mobile computing system built directly into the vehicle such as an auto-mounted computer system with Internet access. All such embodiments are anticipated by FIG. 5 and/or FIG. 6 and their surrounding descriptions.

Referring now to FIG. 6, a method 600 is illustrated in block diagram form. This method, while being practiced by the stand-alone peripheral 500, also defines a method that is practiced by a mobile unit. The mobile unit is similar to the mobile unit 100, but in some embodiments, the mobile unit may not include the flexible-retractable peripheral 135. The flexible-retractable peripheral (FRP) surface 515 is brought into its extended state (605). This action preferably triggers a service advertisement (610). In some embodiments the user may further need to press a button to initiate service advertisement or another service negotiation phase. The service advertisement is a message that allows the mobile unit to become aware of the presence of the peripheral 500 through a service discovery protocol (615). For example, if the peripheral 500 and the mobile unit communicate using the Bluetooth™ air interface, the Bluetooth™ service discovery protocol may be used.

It should be noted that in the method 600, added features beyond traditional service discovery may be used. For example, if the peripheral 500 is supplied in a public area such as an airplane as is subsequently discussed, then the mobile unit and the peripheral 500 (or an associated server) may make a financial contract so that the mobile unit compensates the peripheral 500 for its use. In such cases, 615 involves coupling a message to the associated network server. The peripheral 500 can use its LAN or WAN connection to support a session connection between the mobile unit and the associated network server. The session connection, for example, may involve a secure socket or an IPSEC transport session between the mobile unit and the associated server that contracts the peripheral's services and provides billing and authentication support for the peripheral. That is, the mobile unit and the network server engage in an admission protocol to determine whether the mobile unit will be granted access to the flexible-retractable peripheral service. In some cases, the peripheral may couple a set of admission parameters (e.g., peripheral identifier code and a network address) to the mobile unit and the mobile unit may use its own wireless WAN or LAN connection to communicate directly with the server.

Once the service discovery protocol has been completed, the peripheral 500 becomes coupled to the mobile unit (620). Next the peripheral 500 supplies an extended peripheral service to the mobile unit using the flexible-retractable peripheral 515.

Note that the steps 610, 615, 620 and 625 also involve the mobile unit. When performed in response to the peripheral 500 moving its FRP surface 515 to its extended state, the method 600 defines a method practiced by a mobile unit. When a remote network server acts on behalf of the peripheral 500 and participates in the step 615, then the server practices the method 600.

More specifically, the method 600 as applied to the mobile unit is to receive a service advertisement that has been made in response to the FRP 515 being placed into its extended state (610). The service advertisement can be sent out automatically once the FRP 515 reaches its extended state or possibly with the assistance of a user activating a service button on the peripheral 500. The mobile unit next engages in the service discovery protocol with the peripheral (615). Next the mobile unit reconfigures itself to be coupled to the peripheral 500 and to redirect an input and/or output stream thereto (620). Next the mobile unit executes an application program (possibly a client-server application) and uses the FRP 515 as a display and/or input surface.

The method 600 defines a server system method when a server interacts with the peripheral 500 to supply contracted peripheral extension services. The server connects with the peripheral 500 which itself in such embodiments preferably includes a wide area network connection or at least some type of local area network connection. The peripheral 500 is put in its extended state (605) and advertises its service (610). Next the peripheral 500 and the mobile unit engage in a service discovery protocol (615). The peripheral 500 couples at least some of this service discovery sequence to a remote server (not shown) coupled across a local or wide area network (not shown). In some embodiments the peripheral 500 couples a set of parameters such as the server's network address and a peripheral identification code to the mobile unit so the mobile unit can negotiate the admission sequence with server directly. Either directly or via the peripheral 500 (which in some embodiments includes a wireless or wired LAN or WAN connection), the server and the mobile unit exchange authentication and payment data and agree (e.g., in a session) to contract the peripheral 500 for use of the mobile unit under a service agreement (615). Next the peripheral 500 couples itself to the mobile unit as a service (620) and the mobile unit redirects an input and/or output stream to the FRP 515.

While most of the examples herein discuss mobile Internet type devices, other types of devices may be used with the present invention. For example, the peripheral 500 and the method 600 may be used to support video viewing for entertainment. Much like an MP3™ player is used to allow a user to download audio files and listen to them, a mobile unit can be used as a video player. In such embodiments of the present invention, the peripheral 500 is used as a viewing surface for the video player. A variant of the method 600 is preferably used to couple the hand-held video player to the peripheral 500. The memory 115 is used to store the video program to be viewed. In some embodiments, the video program can stream into the mobile unit via the LAN/WAN interface 150. Video players with the architecture of the mobile unit 300 can also be used. In such cases, the modules 325 and 330 are not typically used.

The peripheral 500 and/or the method 600 are useful in many situations to include vehicular applications. In a preferred embodiment of the present invention, the peripheral 500 is vertically built into the left side of the driver's and co-pilots seats of a car. A person sitting in the back seat can extend the display surface 515 by stretching it from left to right across the back of the seat. Small clasps are preferably provided on the right side of the seat to hold the surface 515 in place once it is extended. A passenger in the back seat with a video player can then watch a movie or a music video, preferably with a Bluetooth™ headset and using the method 600. Of course, the peripheral 500 could be mounted into the seat in different ways, but this is a preferred embodiment.

For example, in accordance with the present invention, a vehicle and/or a vehicle subsystem is provided that has the peripheral 500 built into a portion of the vehicle (e.g., the left-back portion of the driver's seat or the passenger side of the dash board) so that a passenger can extend the surface 515 so as to provide a viewing surface (and possibly an input surface). A wireless or a wired interface is used to allow the passenger to use the viewing surface to support video viewing and/or computer applications. Depending on the embodiment, the passenger may use their own personal mobile unit, or may use a mobile unit built into the vehicle.

It should be noted that such extension peripheral functionality enables handheld mobile computers to include wristwatch computers to become useful. For example a user can download a movie into a handheld device (to include a wristwatch) and views the movie while riding as a passenger in a car, airplane or train (625). If the input capability is also supplied by a peripheral 500, then the user can use the flexible-retractable peripherals to provide a full blown non-area constrained user interface for computer application (625). Moreover, server systems that use interface with the peripherals 500 can use a combination of wireless negotiation techniques supplied by the peripheral 500 and client-server negotiation techniques with the mobile unit in order to supply contracted peripheral services to mobile users (615). This allows a user to carry a very small computer such as a mobile phone or wristwatch computer and to then use it as a full-blown system with a non-area constrained user interface.

Another example is in an airplane. When a passenger lets the tray table down the peripheral 500 becomes exposed. The passenger can pull the surface 515 down like a window blind or have it lowered automatically under motor control. In some embodiments the peripheral 515 remains in an extended state behind the tray table at all times. In some embodiments, the tray table itself also has another peripheral 500 mounted within, for example on the left edge. The user then causes the surface 515 to be extended across the tray table. Now the user can use the surface behind where the tray table goes for a viewing surface for video viewing or computer applications. The surface 515 lying across the tray table can be used as a keyboard. The method 600 may be used to allow the user to gain access to the services offered by these peripherals. A server in the airplane can take part in the step 635 to ensure the proper passenger is using the associated peripheral and to assess a charge to the passenger for its use. In one type of embodiment, the user reads a code from the peripheral 515 and plugs it into his hand-held device. Once the code is entered, it is used in the service discovery sequence 615 in order to ensure the appropriate mobile is coupled to the appropriate peripheral for cases where there are plural passengers and plural sets of peripherals 500 in the same area.

Although the present invention has been described with reference to specific embodiments, other embodiments may occur to those skilled in the art without deviating from the intended scope. In the methods 200 or 600, the order of the steps, substeps or actions may be altered wherever such a change does not render the method inoperable. While Bluetooth™ has been used as a wireless local (personal) area networking technology (short range wireless coupling) by way of example, other wireless technologies such as HomeRF™, IEEE 802.11, point-to-point radio, optical or infrared links, or other short-range wireless protocols can be equivalently used. In certain environments such as auto and airplane systems, the peripheral 500 may be coupled to a fixed vehicle-borne mobile unit (vehicle-mounted computer system). In such cases, certain steps of the methods may be omitted and the coupling between the vehicle mounted computer and the peripheral 500 may make use of wired connections. Also, a “hand-held” device generically implies a size, and such devices may also be wrist-worn, for example. Therefore, it is to be understood that the invention herein encompasses all such embodiments that do not depart from the spirit and scope of the invention as defined in the appended claims.

What is claimed is

1. A flexible-retractable peripheral system comprising:
a flexible-retractable peripheral surface selected from the group consisting of a display and a keyboard;
a coupling that couples signals to and/or from the peripheral to a hand-held mobile computing device.

2. The system of claim 1, further comprising:
a linked support member with movable links that can be tightened to make the flexible-retractable peripheral surface rigid in at least a linear dimension.

3. The system of claim 1, further comprising:
a stand-alone peripheral enclosure that houses the flexible-retractable peripheral system; and
wherein the coupling further comprises a short range wireless transceiver.

4. The system of claim 3, wherein the transceiver operates according to a personal area networking protocol.

5. The system of claim 4, further comprising:
a video decoder circuit;
wherein the flexible-retractable peripheral surface comprises a display surface for video program viewing.

6. The system of claim 3, further comprising an optical isolator that optically couples the flexible-retractable peripheral to the stand-alone peripheral enclosure.

7. The system of claim 3, further comprising:
a vehicle;
wherein the stand-alone peripheral enclosure is mounted into a portion of the vehicle and is able to provide the flexible-retractable peripheral for use by a vehicle passenger.

8. A hand-held mobile unit comprising:
a processor;
a memory;
an area-constrained user interface that provides user input and/or output to the hand-held mobile unit;
a flexible-retractable peripheral selected from the group consisting of a display and a keyboard;
a coupling that selectively couples signals between the flexible-retractable peripheral and the processor; and
a non-area constrained user interface;
wherein the hand-held mobile unit selectively provides the area-constrained user interface and/or the non-area constrained user interface depending on an operating mode of the hand-held mobile unit.

9. The hand-held mobile unit of claim 8 wherein the hand-held mobile unit comprises both the flexible-retractable display and the flexible-retractable keyboard.

10. The hand-held mobile unit of claim 8 wherein the area-constrained user interface includes an input device that is used as a mouse-pointing device for the non-area constrained user interface.

11. The hand-held mobile unit of claim 8 wherein the flexible-retractable peripheral is attached to the hand-held unit by a hinged support structure.

12. The hand-held mobile unit of claim 8 wherein the flexible-retractable peripheral 1 is attached to the hand-held unit by a retractable and downward protruding support structure.

13. The hand-held mobile unit of claim 8, further comprising:
a linked support member with movable links that can be tightened to make the flexible-retractable peripheral rigid in at least a linear dimension.

14. The hand-held mobile unit of claim 8, further comprising:
a wide area network air interface module to support wireless network communications.

15. The hand-held mobile unit of claim 8, further comprising:
a local area network air interface module to support wireless personal area network communications.

16. For use in a stand-alone flexible-retractable peripheral system, a method comprising:
extending a flexible-retractable peripheral, the flexible-retractable peripheral being a selected from the group consisting of a display and a keyboard;
advertising a service via a wireless link, the advertisement indicative of a peripheral service provided by the extended flexible-retractable peripheral;
engaging in a service discovery protocol sequence with a mobile unit via a short-range wireless connection;
coupling the flexible-retractable peripheral service to the mobile unit; and
providing an input and/or output peripheral service to the mobile unit using the extended surface of the flexible-retractable peripheral.

17. The method of claim 16, wherein the advertising of the service is performed automatically in response to the act of extending.

18. The method of claim 16, wherein the act of engaging in service discovery further comprises:
coupling a message to an external network server;
supporting a session connection between the mobile unit and the external network server;
whereby the mobile unit and the network server engage in an admission protocol to determine whether the mobile unit will be granted access to the flexible-retractable peripheral service.

19. The method of claim 16, wherein the stand-alone flexible-retractable peripheral system is vehicle-mounted.

20. The method of claim 19, wherein the stand-alone flexible-retractable peripheral service supports video program viewing.
